(19) United States
(12) Patent Application Publication
(10) Pub. No.: US 2007/0146332 A1
(43) Pub. Date: Jun. 28, 2007

(54) Method of emitting color depending on state of mobile communication terminal and mobile communication terminal using the same

(75) Inventors: Hong-Gu Kim, Hwaseong-si (KR); Joo-Hun Sung, Seongnam-si (KR); Jae-Kwang Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/644,091

(22) Filed: Dec. 22, 2006

(30) Foreign Application Priority Data
Dec. 22, 2005 (KR) 2005-127760

(51) Int. Cl. G09G 5/00

(52) U.S. Cl. 345/170; 345/168

(57) ABSTRACT

A function of emitting a color depending on a state of a mobile communication terminal is implemented. To do this, a keypad of the mobile communication terminal is illuminated with a color corresponding to a sensed result when a predetermined operation or event occurs. In order to illuminate the keypad according to a state of the mobile communication terminal using different colors, a keypad illumination unit includes a light source for generating a plurality of colors and a waveguide layer for diffusing light generated by the light source. Accordingly, a user can easily recognize a state of the mobile communication terminal through a color emitted through the keypad, and interest and convenience of the user can be satisfied with the mobile communication terminal emitting various colors.

### PRIORITY

This application claims priority under 35 U.S.C. § 119 to an application filed in the Korean Intellectual Property Office on Dec. 22, 2005 and assigned Serial No. 2005-127760, the contents of which are incorporated herein by reference.

### BACKGROUND OF THE INVENTION

1. Field of the Invention

The present invention relates generally to a mobile communication terminal, and in particular, to a method of emitting a color depending on a state of a mobile communication terminal and a mobile communication terminal using the same.

2. Description of the Related Art

Recently, mobile communication terminals, such as cellular phones and personal digital assistants (PDAs), which individuals can carry, are seeing widespread use. Such a mobile communication terminal provides communication functions, such as a short message service (SMS) function, and additional functions, such as an alarm function and a silent alert function, according to communication technology development. Thus a user of a mobile communication terminal can use a conventional call function and various convenient functions.

Since additional functions are gradually expanding in response to various demands of users, in order to increase an effective value of mobile communication terminals and satisfy the various demands of users, a high priority is given to providing various services and additional functions to mobile communication terminals.

In particular, according to a general use of mobile communication terminals, a function of allowing a user to conveniently use a mobile communication terminal anytime at any location can also be one of additional functions. A keypad illumination setting function is an example of an additional function that can be implemented to enable easy use of a mobile communication terminal even in a dark environment. The keypad illumination setting function illuminates a keypad according to desires of a user.

A silent alert function is another example that is valuably used as a method of noticing a state of a mobile communication terminal when or where a user is unable to receive a call. The silent alert function informs the user of a reception state of the mobile communication terminal or an incoming message by emitting light using a separate incoming lamp, i.e., a light emitting diode (LED) module.

FIG. 1 is a block diagram of a conventional mobile communication terminal for controlling a keypad illumination unit 20 and an LED module 30, where the mobile communication terminal includes a keypad as a key input device, and a controller 10 outputs a control signal, i.e., an ON/OFF signal, to the keypad illumination unit 20 in order for a user to easily press the keypad and outputs a control signal, i.e., an ON/OFF signal, to the LED module 30 in order to inform the user of an operation state of the mobile communication terminal using light. The keypad illumination unit 20 has LEDs disposed below the keypad in order for the user to use the keypad in a dark place, and enables the user to easily recognize characters on the keypad by emitting light of the LEDs to the keypad.

The LED module 30 has one or two LEDs, which are light emitting elements, and diffuses light of the LED(s) by covering the LED(s).

The keypad illumination unit 20 of the mobile communication terminal emits only a single color when the keypad illumination unit 20 is in an on state due to a pressed key or an open folder. In addition, the LED module 30 for noticing an operation state of the mobile communication terminal is separately disposed on an outer surface of the mobile communication terminal and repeatedly emits several colors. Since the LED module 30 has a limited structure for emitting light of the LEDs, visibility decreases.

Recently, demands of users have become more varied and detailed than in the past. User interface units of mobile communication terminals are therefore being formed to be user recognizable and satisfy user demand. Manufacturing costs and sizes of mobile communication terminals must be considered. However, it is difficult to install an LED module in a size easily recognizable by users, and moreover, since design of LED modules is simple and uniform, it is difficult to satisfy various demands of users. Keypad illumination units also use only one color to emit light.

### SUMMARY OF THE INVENTION

An object of the present invention is to substantially solve at least the above problems and/or disadvantages and to provide at least the advantages below. Accordingly, an object of the present invention is to provide a method of emitting a color depending on a state of a mobile communication terminal in order for a user to easily and visually recognize the state of the mobile communication terminal and a mobile communication terminal using the same.

According to one aspect of the present invention, there is provided a method of emitting a color depending on a state of a mobile communication terminal comprising a keypad and a keypad illumination unit for illuminating the keypad, the method including determining whether the state of the mobile communication terminal is changed; controlling the keypad illumination unit to emit a color depending on the changed state when it is determined that the state of the mobile communication terminal has been changed.

According to another aspect of the present invention, there is provided a mobile communication terminal for emitting a color depending on a state thereof, the mobile communication terminal including a keypad illumination unit for emitting at least one color to illuminate a keypad; and a controller for determining whether the state of the mobile communication terminal is changed, and controlling the keypad illumination unit to emit a color depending on the changed state when it is determined that the state of the mobile communication terminal has been changed.

According to another aspect of the present invention, there is provided a method of emitting a color depending on a state of a mobile communication terminal comprising a single light source for illuminating a keypad and a keypad illumination unit having a waveguide layer for guiding light generated by the light source, the method including determining whether a predetermined operation or event occurs; determining a pre-set color to illuminate the keypad in response to the occurrence of the operation or event; and activating the keypad illumination unit using the determined color.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram of a conventional mobile communication terminal for controlling a keypad illumination unit 20 and an LED module;

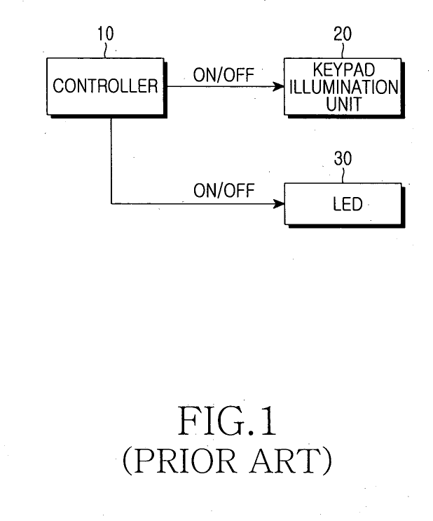

FIG. 2 is a block diagram of a mobile communication terminal for emitting a color depending on an event according to the present invention;

FIG. 3 is a structure of a waveguide for illuminating a keypad according to the present invention;

FIG. 4 is a flowchart illustrating a method of emitting a color depending on an event according to the present invention;

FIG. 5 is a flowchart illustrating a method of emitting a color depending on a key input according to the present invention; and

FIGS. 6A to 6F show examples of a keypad illuminated according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention implements a function of emitting a color depending on a state of a mobile communication terminal. To do this, when a predetermined operation or event in the mobile communication terminal is sensed, a keypad is illuminated with a color corresponding to the sensed result. In order to illuminate the keypad according to a state of the mobile communication terminal using different colors, a keypad illumination unit according to the present invention includes a light source for generating a plurality of colors and a waveguide layer for diffusing light generated by the light source. Accordingly, a user can easily recognize a state of the mobile communication terminal through a color emitted through the keypad, and interest and convenience of the user can be satisfied with the mobile communication terminal emitting various colors.

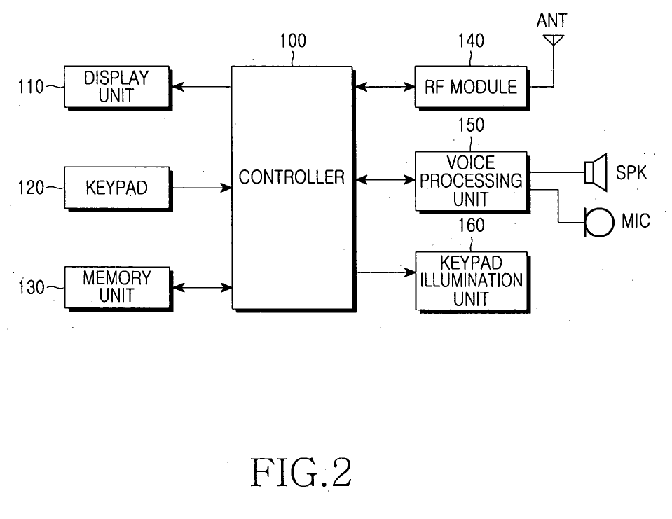

Components and their operations of a mobile communication terminal in which the above-described function is implemented will now be described with reference to FIG. 2. FIG. 2 is a block diagram of a mobile communication terminal for emitting a color depending on an event according to the present invention

, where a controller 100 controls a general operation, such as calling and data transmission and reception, of the mobile communication terminal. The controller 100 senses whether an event, such as an incoming call, an incoming message, an alarm time, or any connection state, occurs, occurs, and the controller 100 controls a keypad illumination unit 160 to emit a color depending on the event. Thus, a user can easily recognize an event, such as an incoming call or an incoming message, through a color emitted by the keypad illumination unit 160.

When a key of a keypad 120 is pressed by the user, the controller 100 controls the keypad illumination unit 160 to emit a color corresponding to the pressed key by referring to key mapping data. The key mapping data is data in which different colors are mapped to keys of the keypad 120. For example, the keypad illumination unit 160 emits a ‘red’ color if the user presses a key “1”, the keypad illumination unit 160 emits a ‘blue’ color if the user presses a key “2”, and the keypad illumination unit 160 emits a ‘green’ color if the user presses a key “3”. That is, various colors are emitted according to pressed keys.

The controller 100 controls a display unit 110 to display data corresponding to key input data input from the keypad 120 or an operating state and various kinds of information of the mobile communication terminal using icons and characters. In addition, when the user sets or operates a necessary function, the display unit 110 allows the user to visually recognize the setting or operating state under a control of the controller 100.

The keypad 120 includes various kinds of keys including number keys and provides key input data input by the user to the controller 100. That is, the keypad 120 outputs unique key input data corresponding to each key when the key is pressed, the key input data output from the keypad 120 is input to the controller 100, and the controller 100 detects which key input corresponds to the key input data and performs a relevant operation according to the detection result.

A memory unit 130 connected to the controller 100 includes Read Only Memory (ROM) for storing a plurality of programs and information needed to control operations of the mobile communication terminal, Random Access Memory (RAM), and voice memory. The memory unit 130 also stores illumination color data in which each event corresponds to a relevant color to control the keypad illumination unit 160 and stores key mapping data in which a different color is mapped to each key.

A radio frequency (RF) module 140 connected to the controller 100 converts voice data and control data to an RF signal and transmits the converted RF signal, and receives an RF signal and converts the received RF signal to voice data and control data. The controller 100 can sense an event, such as an incoming call, an incoming message, or any connection state, based on an RF signal received through the RF module 140.

A voice processing unit 150 connected to the controller 100 converts voice data input from the controller 100 to a voice signal and outputs an audible sound through a speaker, and converts a voice signal input from a microphone to voice data and outputs the converted voice data to the controller 100. The voice processing unit 150 may also output various sound effects according to events through the speaker under a control of the controller 100.

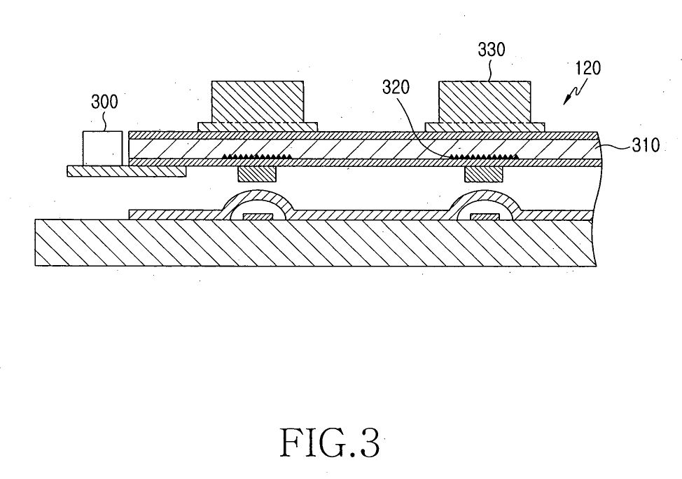

The keypad illumination unit 160 emits a color corresponding to an event under a control of the controller 100. The keypad illumination unit 160 includes a waveguide layer for waveguiding light emitted from a single light source for generating a plurality of colors. Referring to FIG. 3, the keypad 120 includes a plurality of key buttons 330, and the keypad illumination unit 160 includes a light source 300 for generating a plurality of colors and a waveguide layer 310 having protrusions 320 for evenly diffusing light generated by the light source 300. The waveguide layer 310 is disposed below the keypad 120 to be matched to keys of the keypad 120, and light guided through the waveguide layer 310 illuminates characters and/or numbers corresponding to key values assigned to the keypad 120. The light source 300 can be any illuminant for generating a plurality of colors, however, an LED is preferred for the light source 300 since the LED is miniaturized, consumes low power, and can be used for a keypad of a mobile communication terminal.

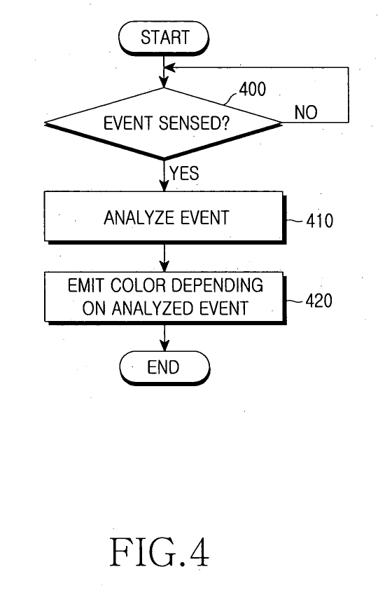

Referring to FIG. 4, the controller 100 senses an event according to a state change of the mobile communication terminal in step 400. More particularly, the controller 100 senses whether an event, such as an incoming call, an incoming message, an alarm time, or any connection state, according to a state change of the mobile communication terminal occurs. If an event is sensed, the controller 100 analyzes the sensed event in step 410. That is, the controller 100 analyzes that the sensed event corresponds to a state change of the mobile communication terminal. The controller 100 controls the keypad illumination unit 160 to emit a color depending on the analyzed event in step 420 by referring to pre-set illumination color data. The light source 300 generates light having a color corresponding to the event, and then the light is diffused through the waveguide layer 310, illuminating characters and/or numbers of the keypad 120 with the color corresponding to the event. Herein, “color depending on an event” indicates that a different color is emitted according to an event. That is, a different color is emitted according to the changed state.

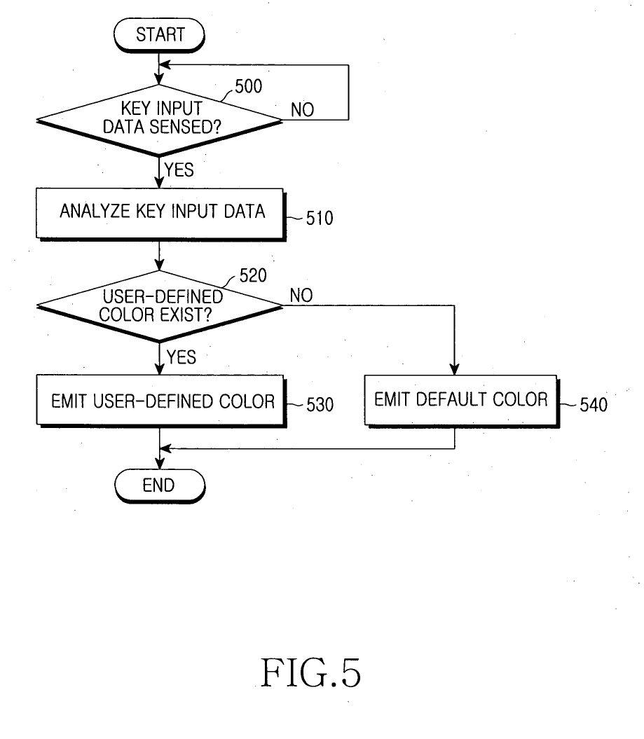

Referring to FIG. 5, the controller 100 determines in step 500 whether key input data through the keypad 120 is sensed according to a key pressed by the user. If key input data is sensed as the determination result, the controller 100 analyzes the key input data in step 510. That is, the controller 100 analyzes that the key input data corresponds to a key by analyzing the key input data. The controller 100 determines in step 520 whether a user-defined color corresponding to the key input data exists by referring to key mapping data. The key mapping data is pre-set for the keypad illumination unit 160 to emit a color corresponding to a key pressed by the user every time.

If it is determined in step 520 that a user-defined color corresponding to the key input data exists, the controller 100 controls the keypad illumination unit 160 to emit the user-defined color in step 530. If it is determined in step 520 that a user-defined color corresponding to the key input data does not exist, the controller 100 controls the keypad illumination unit 160 to emit a default color.

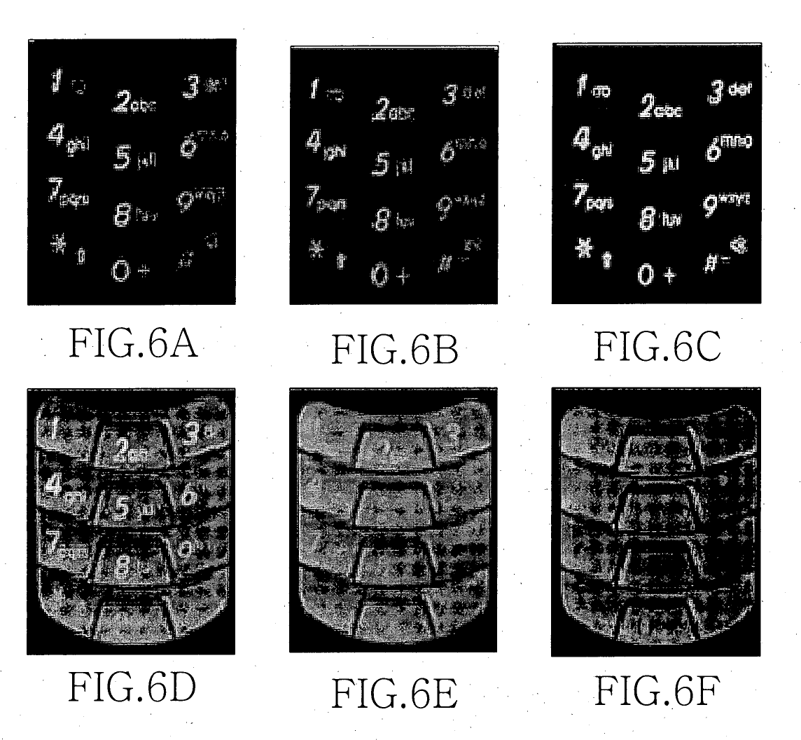

For example, since predetermined colors respectively correspond to various events or keys, characters and/or numbers of the keypad 120 can be variously illuminated as illustrated in FIGS. 6A to 6F. The user can easily recognize a current state of the mobile communication terminal by the keypad illumination unit emitting a different color every time a state of the mobile communication terminal is changed, i.e., an event occurs or a key is pressed.

As described above, according to the present invention, a user can easily and visually recognize a state of a mobile communication terminal. In addition, a manufacturing cost can be reduced by emitting a plurality of colors using a single light source for generating light having the plurality of colors and a waveguide layer without using a plurality of LEDs.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of emitting a color depending on a state of a mobile communication terminal comprising a keypad and a keypad illumination unit for illuminating the keypad, the method comprising:
determining whether the state of the mobile communication terminal is changed; and
controlling the keypad illumination unit to emit a color depending on the changed state when it is determined that the state of the mobile communication terminal has been changed.

2. The method of claim 1, wherein the step of determining whether the state of the mobile communication terminal is changed comprises determining whether an event of an incoming call, an incoming message, an alarm time, or any connection state is sensed.

3. The method of claim 1, wherein the step of determining whether the state of the mobile communication terminal is changed comprises determining whether key input data according to a key pressed by a user is sensed.

4. The method of claim 2, further comprising determining a color to be emitted according to the sensed event when an event is sensed as the determination result.

5. The method of claim 3, further comprising determining a color to be emitted according to the sensed key input data when key input data is sensed as the determination result.

6. The method of claim 1, wherein the step of controlling the keypad illumination unit comprises diffusing light having a color depending on the state change by providing a single light source for generating a plurality of colors outside through a waveguide layer by controlling the light source.

7. A mobile communication terminal for emitting a color depending on a state thereof, the mobile communication terminal comprising:
a keypad illumination unit for emitting at least one color to illuminate a keypad; and
a controller for determining whether the state of the mobile communication terminal is changed, and controlling the keypad illumination unit to emit a color depending on the changed state when it is determined that the state of the mobile communication terminal has been changed.

8. The mobile communication terminal of claim 7, wherein the state change is determined by sensing an event of an incoming call, an incoming message, an alarm time, or any connection state.

9. The mobile communication terminal of claim 7, wherein the state change is determined by sensing key input data according to a key pressed by a user.

10. The mobile communication terminal of claim 7, wherein the keypad illumination unit comprises:
a light source for generating light with one of a plurality of colors under a control of the controller; and
a waveguide layer for guiding light having a color depending on the state change that is generated by the light source, to illuminate the keypad.

11. The mobile communication terminal of claim 7, wherein the controller determines a color to be emitted according to the sensed event when an event is sensed as the determination result.

12. The mobile communication terminal of claim 7, wherein the controller determines a color to be emitted according to the sensed key input data when key input data is sensed as the determination result.

13. A method of emitting a color depending on a state of a mobile communication terminal comprising a single light source for illuminating a keypad and a keypad illumination unit having a waveguide layer for guiding light generated by the light source, the method comprising:
determining whether a predetermined operation or event occurs;
determining a pre-set color to illuminate the keypad in response to occurrence of an operation or event; and
activating the keypad illumination unit using the determined color.

14. The method of claim 13, wherein the operation or event is one of an incoming call, an incoming message, an alarm time, or any connection state.

15. The method of claim 13, wherein the predetermined operation occurs according to a key pressed by a user.

16. The method of claim 13, wherein the step of activating the keypad illumination unit comprises controlling the keypad illumination unit to emit a different color for each event using the light source generating a plurality of colors.

17. A mobile communication terminal for emitting a color depending on a state thereof, which comprises a single light source for illuminating a keypad and a keypad illumination unit having a waveguide layer for guiding light generated by the light source, the mobile communication terminal comprising:
the keypad illumination unit for emitting at least one color using the light source for generating light having a plurality of colors to illuminate the keypad; and
a controller for determining whether a state of the mobile communication terminal is changed, and controlling the keypad illumination unit to emit a color corresponding to the changed state when the state is changed.

18. The mobile communication terminal of claim 17, wherein the controller determines a pre-set color corresponding to the sensed event and activates the keypad illumination unit with the determined color when an event of an incoming call, an incoming message, or an alarm time, is sensed.

19. The mobile communication terminal of claim 17, wherein the controller determines a pre-set color corresponding to the pressed key and activates the keypad illumination unit with the determined color when a key is pressed.
